(19) United States
(12) Patent Application Publication
(10) Pub. No.: US 2018/0084223 A1
(43) Pub. Date: Mar. 22, 2018

(54) CONTENT REPRODUCTION APPARATUS, CONTENT REPRODUCTION METHOD AND STORAGE MEDIUM

(71) Applicant: CASIO COMPUTER CO., LTD., Tokyo (JP)

(72) Inventor: Yuji Abe, Tokyo (JP)

(21) Appl. No.: 15/704,836

(22) Filed: Sep. 14, 2017

(30) Foreign Application Priority Data
Sep. 16, 2016 (JP) 2016-181141

(51) Int. Cl. H04N 7/14; H04L 29/06

(52) U.S. Cl. CPC H04N 7/147; H04N 9/31; H04L 65/1059

(57) ABSTRACT

A content reproduction apparatus includes a hardware processor. The hardware processor is configured to send data that is used in a function of a first communication device to the first communication device while a reproduction unit reproduces content introducing the function.

### CROSS-REFERENCE TO RELATED APPLICATION

This application is based upon and claims the benefit of priority from the prior Japanese Patent Application No. 2016-181141, filed on Sep. 16, 2016, the entire contents of which are incorporated herein by reference.

### BACKGROUND OF THE INVENTION

### 1. Field of the Invention

The present invention relates to a content reproduction apparatus, a content reproduction method and a storage medium.

### 2. Description of the Related Art

There have been known video output apparatuses each of which projects advertisement content onto a screen formed in the shape of the contour of a character or the like in the content, thereby increasing impressions on viewers.

For example, a video output apparatus described in Japanese Patent Application Publication No. 2011-150221 merely outputs one-sided (non-interactive) video, and hence cannot let customers have simulated experiences with a function of a product, such as a function of a communication device, being introduced by content.

### SUMMARY OF THE INVENTION

According to an aspect of the present invention, there is provided a content reproduction apparatus including a hardware processor, wherein the hardware processor is configured to: send data that is used in a function of a first communication device to the first communication device while a reproduction unit reproduces content introducing the function.

### BRIEF DESCRIPTION OF THE DRAWING

The present invention is fully understood from the detailed description given hereinafter and the accompanying drawings, which are given byway of illustration only and thus are not intended to limit the present invention, wherein:

FIG. 1 shows an example of the overall configuration of a content reproduction system according to embodiments of the present invention;

FIG. 2 is a block diagram showing the functional configuration of a digital signage apparatus shown in FIG. 1;

FIG. 3 schematically shows the configuration of the digital signage apparatus shown in FIG. 1;

FIG. 4 is a block diagram showing the functional configuration of a smartwatch shown in FIG. 1;

FIG. 5 shows flow of a process performed by the digital signage apparatus and the smartwatch when an instruction to start reproducing content introducing a call reception function is input through an operation unit of the digital signage apparatus;

FIG. 6A shows an example of a call reception content;

FIG. 6B shows an example of a talking content;

FIG. 6C shows an example of a disconnection content;

FIG. 7A shows an example of an incoming call screen;

FIG. 7B shows an example of a talking screen;

FIG. 8 shows flow of a process performed by the digital signage apparatus and the smartwatch when an instruction to start reproducing content introducing a message reception function is input through the operation unit of the digital signage apparatus;

FIG. 9A shows an example of a message reception content reproduced in Step S22;

FIG. 9B shows an example of a voice message reception content;

FIG. 9C shows an example of a message reception content reproduced in Step S34;

FIG. 10A shows an example of a message reception screen displayed in Step S24;

FIG. 10B shows an example of a reply screen;

FIG. 10C shows an example of a reply done screen;

FIG. 10D shows an example of a message reception screen displayed in Step S36;

FIG. 11 shows flow of a process performed by the digital signage apparatus and the smartwatch when an instruction to start reproducing content introducing a news reception function is input through the operation unit of the digital signage apparatus;

FIG. 12 shows an example of a news reception content; and

FIG. 13 shows an example of a news reception screen.

### DETAILED DESCRIPTION OF THE PREFERRED EMBODIMENTS

Hereinafter, embodiments of the present invention are described in detail with reference to the drawings. However, the present invention is not limited to the illustrated examples.

### Configuration of Content Reproduction System 100

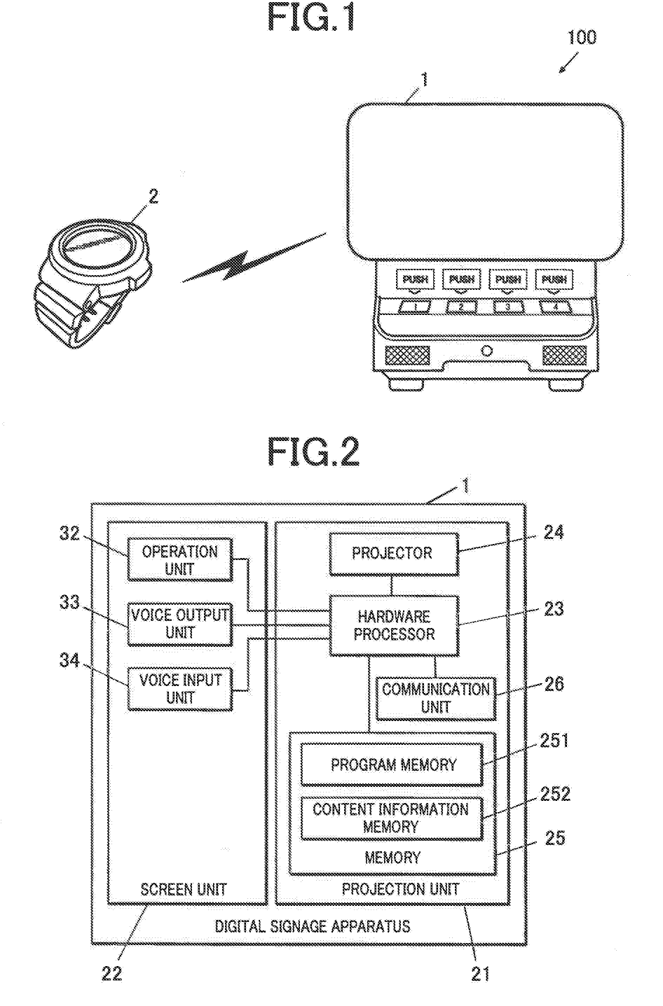

FIG. 1 shows the overall configuration of a content reproduction system 100 according to embodiments of the present invention. As shown in FIG. 1, the content reproduction system 100 includes a digital signage apparatus 1 (content reproduction apparatus) and a smartwatch 2 (first communication device).

### Configuration of Digital Signage Apparatus 1

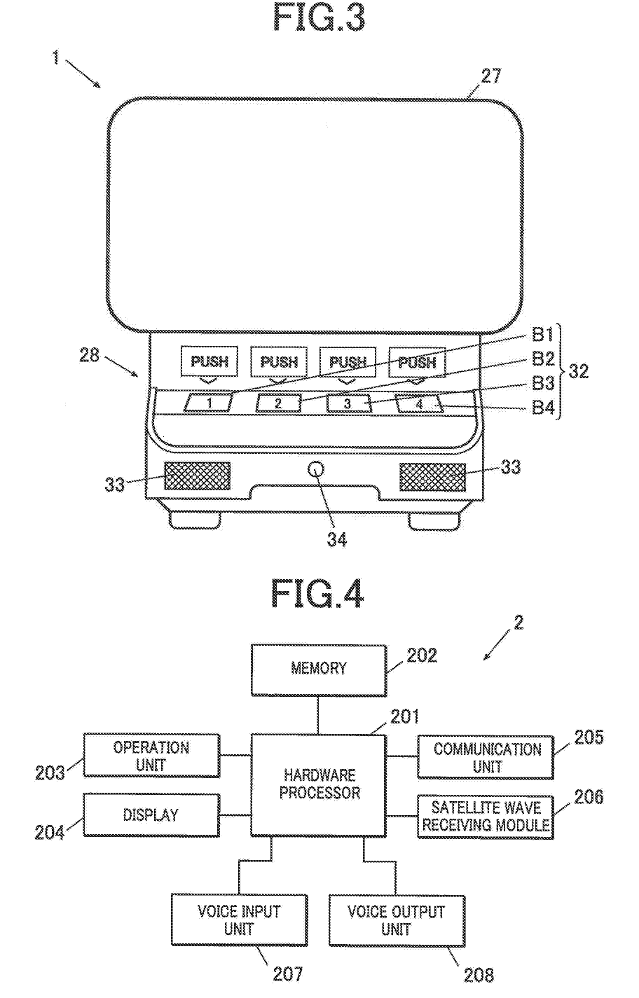

FIG. 2 is a block diagram showing main components of the digital signage apparatus 1 to perform control. FIG. 3 is a front view schematically showing the configuration of the digital signage apparatus 1.

The digital signage apparatus 1 is an apparatus that is placed at a store or the like and reproduces content introducing each function of a communication device such as the smartwatch 2. As shown in FIG. 2, the digital signage apparatus 1 includes a projection unit 21 and a screen unit 22. The projection unit 21 emits video light of content. The screen unit 22 receives, on the rear, the video light emitted from the projection unit 21, and projects the light onto the front.

First, the projection unit 21 is described.

The projection unit 21 includes a hardware processor 23, a projector 24, a memory 25 and a communication unit 26. As shown in FIG. 2, the projector 24, the memory 25 and the communication unit 26 are connected to the hardware processor 23.

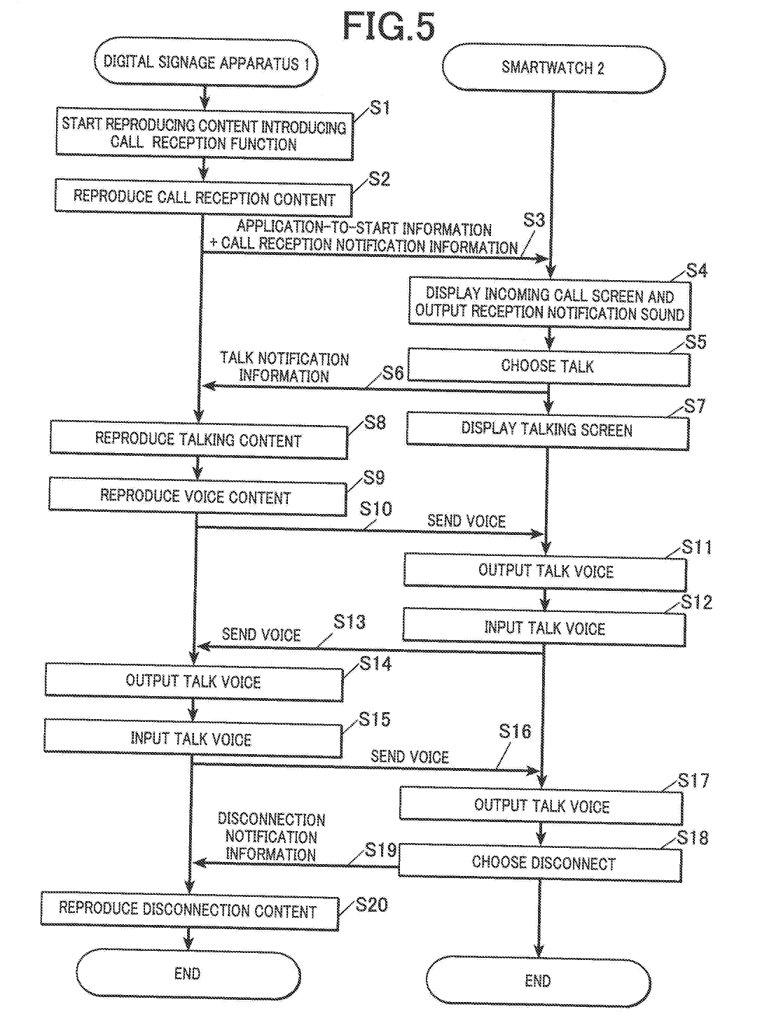

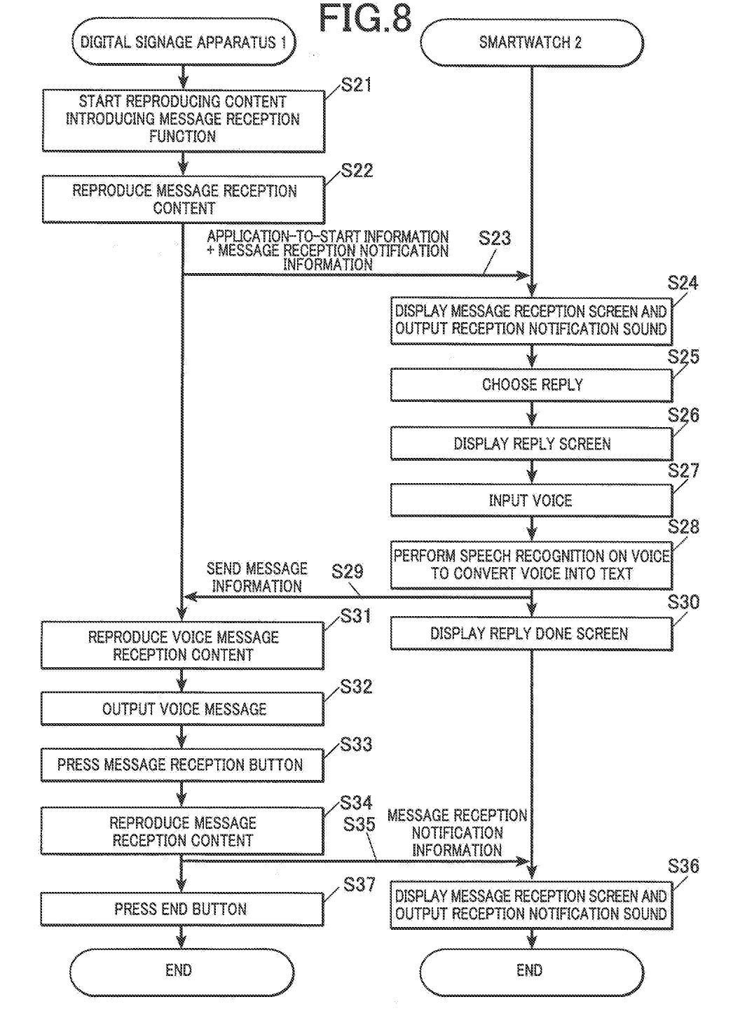

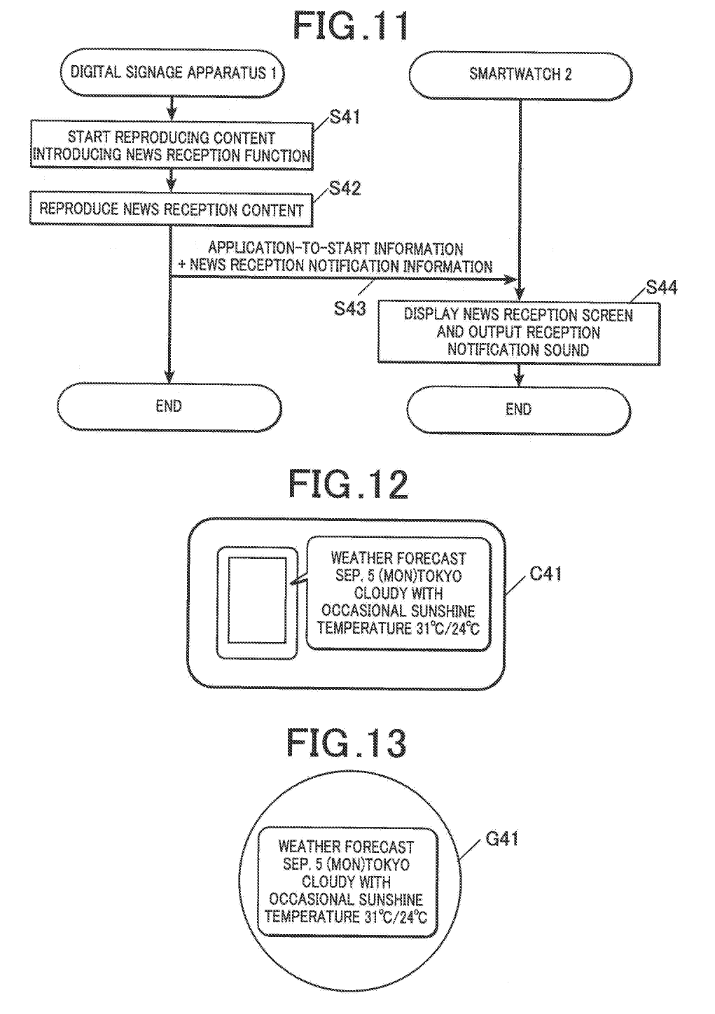

The hardware processor 23 includes a CPU and a memory (both not shown). The CPU executes various programs stored in a program memory 251 of the memory 25 to perform predetermined arithmetic operations and to control the components of the digital signage apparatus 1. The memory serves as a work area when the programs are executed. The hardware processor 23 performs various processes including processes (steps) on the digital signage apparatus 1 side shown in FIG. 5, FIG. 8 and FIG. 11 in cooperation with the programs stored in the program memory 251 of the memory 25. The hardware processor 23 functions as a hardware processor.

The projector 24 is a projector that converts image data output from the hardware processor 23 into video light and emits the video light to the screen unit 22. As the projector 24, for example, a DLP® (Digital Light Processing) projector using a DMD (Digital Micromirror Device) can be used. The DMD is a display element constituted of micromirrors arranged in an array (in the case of XGA, 1024 pixels (width)×768 pixels (height)). The inclination angles of the micromirrors are individually controlled at high speed to individually be the ON state or the OFF state so that display action is performed, and the reflected light forms optical images. The projector 24 functions as a reproduction unit in cooperation with an image formation unit 27.

The memory 25 is constituted of, for example, an HDD (Hard Disk Drive) or a nonvolatile semiconductor memory. As shown in FIG. 2, the memory 25 includes the program memory 251. The program memory 251 stores therein a system program and various process programs of various processes that are executed by the hardware processor 23, data necessary for execution of these programs, and so forth.

The memory 25 also includes a content information memory 252. The content information memory 252 stores therein multiple kinds of content information on (content data of) content that is reproduced by the digital signage apparatus 1, in such away as to be correlated with their respective content numbers to identify the respective kinds of content. Each of these kinds of content information contains image data of frame images constituting content and voice data for the respective frame images.

In this embodiment, the content information memory 252 stores therein at least content information on content introducing a call reception function of the smartwatch 2, content information on content introducing a message reception function of the smartwatch 2 and content information on content introducing a news reception function of the smartwatch 2. Each content is formed of a plurality of (a set of) contents. Each content information is correlated and stored with a reproducing time (time elapses from the start of reproduction of the content introducing a function of the smartwatch 2, hereinafter may be called “introducing content”) of a content that is reproduced when data that is used in the function being introduced by the introducing content is sent to the smartwatch 2, as time to send the data to the smartwatch 2 (hereinafter called “event occurrence time”).

The communication unit 26 has, for example, an interface to communicate with external communication device(s) such as the smartwatch 2. The communication unit 26 sends and receives data to and from the external communication device(s) in conformity with a wireless communication standard such as Bluetooth® or Wi-Fi (Wireless Fidelity).

Next, the screen unit 22 is described.

As shown in FIG. 3, the screen unit 22 includes the image formation unit 27 and a pedestal 28 that holds the image formation unit 27.

The image formation unit 27 is a screen configured such that a film-shaped Fresnel lens-overlaid film screen for rear projection is attached to a translucent plate, such as an acrylic plate, and disposed approximately at right angles to a direction in which video light is emitted. The image formation unit 27 receives the video light emitted from the projector 24 on the rear and displays the light (video) on the front.

The pedestal 28 is provided with a button-type operation unit 32, a voice output unit 33 and a voice input unit 34.

The operation unit 32 includes four operation buttons B1 to B4, and detects press signals of the operation buttons and outputs the signals to the hardware processor 23. In the embodiment, the button B1 is to issue an instruction to start reproducing the content introducing the call reception function, the button B2 is to issue an instruction to start reproducing the content introducing the message reception function, and the button B3 is to issue an instruction to start reproducing the content introducing the news reception function.

The voice output unit 33 is constituted of a speaker or the like, and outputs voices based on voice data instructed by the hardware processor 23. The voice output unit 33 functions as the reproduction unit/a voice output unit.

The voice input unit 34 is constituted of a microphone or the like, and converts voices into electric signals and outputs the signals to the hardware processor 23.

The operation unit 32, the voice output unit 33 and the voice input unit 34 are, as shown in FIG. 2, connected to the hardware processor 23.

### Configuration of Smartwatch 2

The smartwatch 2 is a wearable communication device (wearable terminal) that can be attached to a wrist of a user. The smartwatch 2 includes, as shown in FIG. 4, a hardware processor 201, a memory 202, an operation unit 203, a display 204, a communication unit 205, a satellite wave receiving module 206, a voice input unit 207 and a voice output unit 208.

The hardware processor 201 includes a CPU and a memory (both not shown). The CPU executes various programs stored in the memory 202 to perform predetermined arithmetic operations and to control the components of the smartwatch 2. The memory serves as a work area when the programs are executed. The hardware processor 201 measures time based on not-shown clock signals. The hardware processor 201 performs various processes including processes (steps) on the smartwatch 2 side shown in FIG. 5, FIG. 8 and FIG. 11 in cooperation with the programs stored in the memory 202.

The memory 202 is constituted of, for example, a nonvolatile semiconductor memory. The memory 202 stores therein a system program and various process programs (application programs) that are executed by the hardware processor 201, data necessary for execution of these programs, and so forth.

The operation unit 203 includes a push-button switch(es) and a touch sensor(s), and accepts input operations of a user, converts contents of the operations into electric signals and outputs the signals to the hardware processor 201.

The display 204 is constituted of an LCD (Liquid Crystal Display) or the like, and performs various types of display on its screen in response to display control signals from the hardware processor 201.

The communication unit 205 has, for example, an interface to communicate with external apparatus(es) such as the digital signage apparatus 1. The communication unit 205 sends and receives data to and from the external apparatus(es) in conformity with a wireless communication standard such as Bluetooth® or Wi-Fi.

The satellite wave receiving module 206 has a not-shown antenna, and catches, receives and modulates radio waves from positioning satellites (here, at least radio waves from satellites (GPS satellites) relevant to GPS (Global Positioning System)) so as to obtain time and location.

The voice input unit 207 is constituted of a microphone or the like, and converts voices into electric signals and outputs the signals to the hardware processor 201.

The voice output unit 208 is constituted of a speaker or the like, and outputs voices based on voice data instructed by the hardware processor 201.

### Actions of Content Reproduction System 100

Next, actions of the content reproduction system 100 of the embodiment are described.

The smartwatch 2 has functions that are realized by cooperating with a smartphone (second communication device). Examples thereof include a function of receiving calls received on the smartphone (call reception function), a function of receiving messages received on the smartphone (message reception function), and a function of receiving news, such as weather forecasts, earthquake early warnings and real-time stock quotes, received on the smartphone (news reception function). Letting customers experience behaviors of the smartwatch 2 in these functions can enrich explanations about the functions. However, these functions cannot be realized without the smartphone, which cooperates with the smartwatch 2, receiving a call, a message or news. Hence, it has been difficult to let customers have the experiences at a store.

In addition, salespersons are often forbidden from bringing their smartphones to selling spaces.

Hence, while reproducing content introducing a function of the smartwatch 2, the function being realized in cooperation with a smartphone, the digital signage apparatus 1 of the content reproduction system 100 sends data that is used in the function to the smartwatch 2, which can let customers have simulated experiences of the behaviors of the smartwatch 2 in the function at a store. Hereinafter, simulated experiences with the functions of the smartwatch 2 by use of the digital signage apparatus 1 are described.

### Simulated Experiences with Call Reception Function

FIG. 5 shows flow of a process performed by the digital signage apparatus 1 and the smartwatch 2 when the button B1 of the operation unit 32 is pressed (pushed) and thereby issues an instruction to start reproducing the content introducing the call reception function. Steps of the process on the digital signage apparatus 1 side shown in FIG. 5 is performed by the hardware processor 23 in cooperation with the program(s) stored in the program memory 251. Steps of the process on the smartwatch 2 side shown in FIG. 5 is performed by the hardware processor 201 in cooperation with the program(s) stored in the memory 202.

In the digital signage apparatus 1, when the button B1 of the operation unit 32 is pressed, the hardware processor 23 starts reproducing the content introducing the call reception function of the smartwatch 2 (Step S1). That is, the hardware processor 23 reads the content information on the content introducing the call reception function from the content information memory 252, and projects/displays, with the projector 24, images of the content based on the image data in the read content information on the image formation unit 27. Further, the hardware processor 23 outputs, with the voice output unit 33, voices of the content based on the voice data in the read content information.

In the content introducing the call reception function, for example, first, a content in which a character explains the call reception function, by saying “On the smartwatch, you can receive a call received on a smartphone having been paired with the smartwatch. You can take a call and talk, or disconnect it.” or the like is reproduced, and next, a video content in which the character is making a call is reproduced.

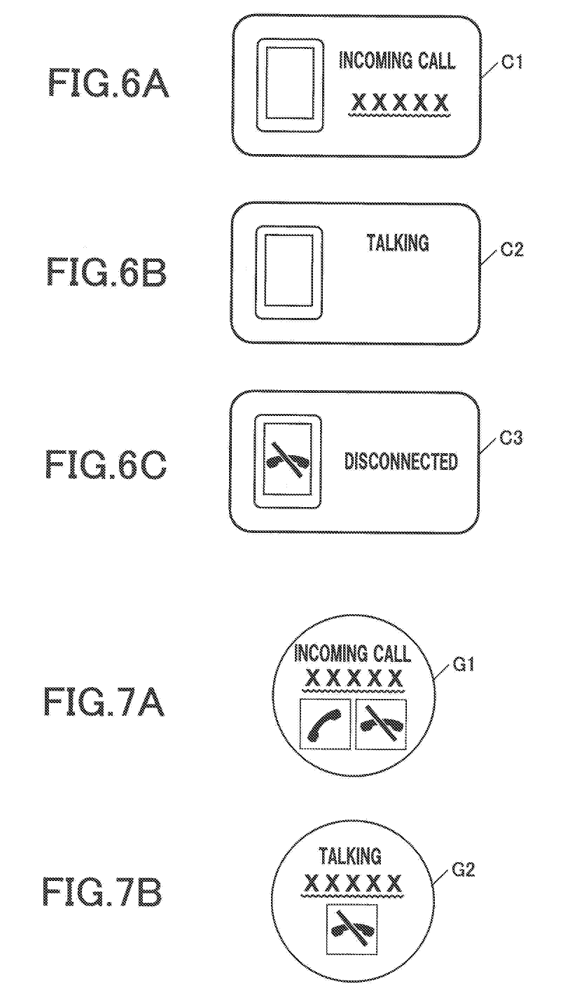

Next, the hardware processor 23 reproduces, with the projector 24 and the voice output unit 33, a call reception content C1 showing that a call is received on the smartphone (Step S2). FIG. 6A shows an example of the call reception content C1. Time at which this call reception content C1 is reproduced is time at which an event to the smartwatch 2 occurs (i.e. the event occurrence time). Hence, the hardware processor 23 sends application-to-start information and call reception notification information to the smartwatch 2 through the communication unit 26 (Step S3). The application-to-start information is information to identify an application to start to realize the call reception function in the smartwatch 2. The call reception notification information is information to notify that a call is received on the smartphone and contains information on a caller of the call or the like.

In the smartwatch 2, when receiving the application-to-start information and the call reception notification information through the communication unit 205, the hardware processor 201 starts the application identified by the application-to-start information, and thereby displays an incoming call screen G1 on the display 204 and outputs a reception notification sound with the voice output unit 208 (Step S4). FIG. 7A shows an example of the incoming call screen G1. As shown in FIG. 7A, on the incoming call screen G1, an indication “Incoming Call”, caller information “XXXXX”, and a talk button and a disconnect button to choose between “Talk” and “Disconnect” are displayed, for example.

When “Talk” on the incoming call screen G1 is chosen/pressed with the operation unit 203 (Step S5), the hardware processor 201 sends talk notification information to the digital signage apparatus 1 through the communication unit 205 (Step S6), and displays a talking screen G2 on the display 204 (Step S7). The talk notification information is information to notify that the call is accepted. FIG. 7B shows an example of the talking screen G2. As shown in FIG. 7B, on the talking screen G2, an indication “Talking”, the caller information and the disconnect button are displayed, for example.

In the digital signage apparatus 1, when receiving the talk notification information through the communication unit 26, the hardware processor 23 reproduces a talking content C2 with the projector 24 (Step S8). FIG. 6B shows an example of the talking content C2. While displaying the talking content C2, the hardware processor 23 outputs (reproduces) a voice content of conversation, such as “Hi.” with the voice output unit 33 (Step S9), and sends the reproduced voice to the smartwatch 2 through the communication unit 26 (Step S10).

In the smartwatch 2, when receiving the voice from the digital signage apparatus 1, the hardware processor 201 outputs, with the voice output unit 208, the received voice as a talk voice (Step S11). When a talk voice is input with the voice input unit 207 (Step S12), the hardware processor 201 sends the input voice to the digital signage apparatus 1 through the communication unit 205 (Step S13).

In the digital signage apparatus 1, when receiving the voice from the smartwatch 2, the hardware processor 23 outputs the received voice with the voice output unit 33 (Step S14).

Here, if a salesperson or the like inputs a talk voice with the voice input unit 34 (Step S15), the hardware processor 23 sends the input voice to the smartwatch 2 through the communication unit 26 (Step S16).

In the smartwatch 2, when receiving the voice from the digital signage apparatus 1 through the communication unit 205, the hardware processor 201 outputs the received voice with the voice output unit 208 (Step S17).

When the disconnect button is pressed with the operation unit 203 (Step S18), the hardware processor 201 sends disconnection notification information to notify that the call is disconnected to the digital signage apparatus 1 through the communication unit 205 (Step S19).

In the digital signage apparatus 1, when receiving the disconnection notification information through the communication unit 26, the hardware processor 23 displays, with the projector 24, a disconnection content C3 showing that the call is disconnected (Step S20), and stops reproducing the content introducing the call reception function. FIG. 6C shows an example of the disconnection content C3.

Then, the hardware processor 23 returns to reproduction of normal content (predetermined content).

Thus, during reproduction of the content introducing the call reception function of the smartwatch 2, the hardware processor 23 of the digital signage apparatus 1 sends data of the information (i.e. start-to-application information) on the application to realize the call reception function in the smartwatch 2 and data of the call reception notification information to notify that a call is received on the smartphone to the smartwatch 2 through the communication unit 26 when the image formation unit 27 and the voice output unit 33 reproduce the call reception content showing that a call is received on the smartphone. Hence, when the digital signage apparatus 1 reproduces the call reception content showing that a call is received on the smartphone, the smartwatch 2 starts the application to realize the call reception function in the smartwatch 2, and thereby displays the incoming call screen G1 and outputs the reception notification sound. This can let customers have simulated experiences of the behaviors of the smartwatch 2 when a call is received on the smartphone.

Further, when receiving, from the smartwatch 2, the talk notification information to notify that the call is accepted, the hardware processor 23 reproduces the talking content showing that the call is accepted. This can let customers have simulated experiences of the behaviors of the smartphone when “Talk” is chosen/pressed on the smartwatch 2.

Further, when, from the smartwatch 2, receiving a talk voice after receiving the talk notification information, the hardware processor 23 outputs the received voice with the voice output unit 33. This can let customers have simulated experiences on how it sounds on the party's side when a talk voice is input on the smartwatch 2 to reply to a call received on the smartphone.

Further, when a talk voice is input with the voice input unit 34 after the hardware processor 23 receives the talk notification information from the smartwatch 2, the hardware processor 23 sends the input voice to the smartwatch 2. This allows the smartwatch 2 to reproduce a reply voice of the party to a voice that has been input on the smartwatch 2 to reply to a call received on the smartphone, and accordingly can let customers have simulated experiences on talks using the smartwatch 2.

Further, when receiving, from the smartwatch 2, the disconnection notification information to notify that the call is disconnected, the hardware processor 23 reproduces the disconnection content showing that the call is disconnected. This can let customers confirm behaviors of the smartphone when a call is disconnected on the smartwatch 2.

### Simulated Experiences with Message Reception Function

FIG. 8 shows flow of a process performed by the digital signage apparatus 1 and the smartwatch 2 when the button B2 of the operation unit 32 is pressed and thereby issues an instruction to start reproducing the content introducing the message reception function. Steps of the process on the digital signage apparatus 1 side shown in FIG. 8 is performed by the hardware processor 23 in cooperation with the program(s) stored in the program memory 251. Steps of the process on the smartwatch 2 side shown in FIG. 8 is performed by the hardware processor 201 in cooperation with the program(s) stored in the memory 202.

In the digital signage apparatus 1, when the button B2 of the operation unit 32 is pressed, the hardware processor 23 starts reproducing the content introducing the message reception function of the smartwatch 2 (Step S21). That is, the hardware processor 23 reads the content information on the content introducing the message reception function from the content information memory 252, and projects/displays, with the projector 24, images of the content based on the image data in the read content information on the image formation unit 27. Further, the hardware processor 23 outputs, with the voice output unit 33, voices of the content based on the voice data in the read content information.

In the content introducing the message reception function, for example, first, a content in which a character explains the message reception function, by saying “On the smartwatch, you can receive a message received on a smartphone having been paired with the smartwatch. You can reply too.” or the like is reproduced, and next, a video content in which the character is entering a message, such as “Hi!!”, is reproduced.

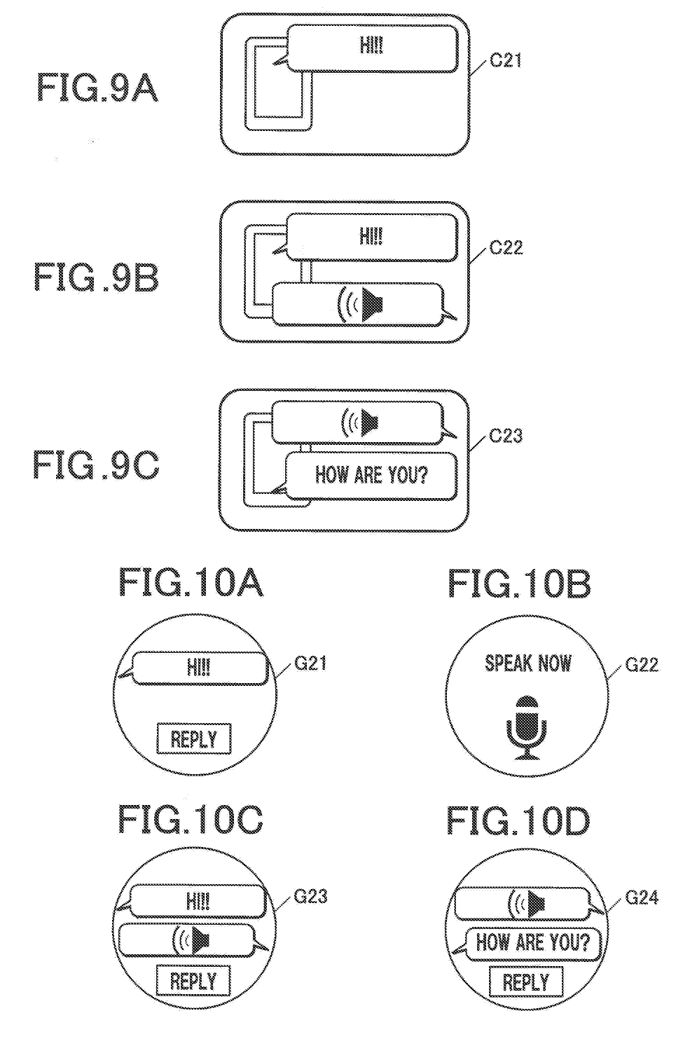

Next, the hardware processor 23 reproduces, with the projector 24 and the voice output unit 33, a message reception content C21 showing that a message is received on the smartphone (Step S22). FIG. 9A shows an example of the message reception content C21. Time at which this message reception content C21 is reproduced is time at which an event to the smartwatch 2 occurs (i.e. the event occurrence time). Hence, the hardware processor 23 sends application-to-start information and message reception notification information to the smartwatch 2 through the communication unit 26 (Step S23). The application-to-start information is information to identify an application to start to realize the message reception function in the smartwatch 2. The message reception notification information is information to notify the message received on the smartphone.

In the smartwatch 2, when receiving the application-to-start information and the message reception notification information through the communication unit 205, the hardware processor 201 starts the application identified by the application-to-start information, and thereby displays a message reception screen G21 on the display 204 and outputs a reception notification sound with the voice output unit 208 (Step S24). FIG. 10A shows an example of the message reception screen G21. As shown in FIG. 10A, on the message reception screen G21, the received message and a “Reply” button are displayed, for example.

When “Reply” on the message reception screen G21 is pressed with the operation unit 203 (Step S25), the hardware processor 201 displays a reply screen G22 on the display 204 (Step S26). FIG. 10B shows an example of the reply screen G22. As shown in FIG. 10B, on the reply screen G22, an indication “Speak Now” and a microphone mark are displayed, for example.

When a voice message is input with the voice input unit 207 (Step S27), the hardware processor 201 performs speech recognition on the input voice message to convert the voice message into a text (Step S28), sends the text information on the message information to the digital signage apparatus 1 through the communication unit 205 (Step S29), and displays a reply done screen G23 on the display 204 (Step S30). FIG. 10C shows an example of the reply done screen G23.

In the digital signage apparatus 1, when receiving the message information from the smartwatch 2 through the communication unit 26, the hardware processor 23 reproduces, with the projector 24, a voice message reception content C22 showing that a message is received (Step S31), and also reproduces (outputs) the received message information with the voice output unit 33 (Step S32). FIG. 9B shows an example of the voice message reception content C22.

During reproduction of the content introducing the message reception function, the buttons B1 to B3 function as message reception buttons, and when one of the buttons B1 to B3 is pressed, a message reception content C23 showing that a predetermined message is received on the smartphone is reproduced, and the message reception notification information is sent to the smartwatch 2. Further, the button B4 functions as an end button, and when the button B4 is pressed, the content introducing the message reception function is ended.

When one of the buttons B1 to B3 of the operation unit 32 is pressed (Step S33), the hardware processor 23 reproduces, with the projector 24, the message reception content C23 showing that a message is received on the smartphone (Step S34), and sends the message reception notification information to the smartwatch 2 through the communication unit 26 (Step S35). FIG. 9C shows an example of the message reception content C23.

In the smartwatch 2, when receiving the message reception notification information through the communication unit 205, the hardware processor 201 displays a message reception screen G24 on the display 204 and outputs the reception notification sound with the voice output unit 208 (Step S36). FIG. 10D shows an example of the message reception screen G24.

In the digital signage apparatus 1, when the button B4 is pressed, the hardware processor 23 stops reproducing the content introducing the message reception function, and returns to reproduction of the normal content.

Thus, during reproduction of the content introducing the message reception function of the smartwatch 2, the hardware processor 23 of the digital signage apparatus 1 sends data of the information (i.e. start-to-application information) on the application to realize the message reception function in the smartwatch 2 and data of the message reception notification information to notify that a message is received on the smartphone to the smartwatch 2 through the communication unit 26 when the image formation unit 27 and the voice output unit 33 reproduce the message reception content showing that a message is received on the smartphone. Hence, when the digital signage apparatus 1 reproduces the message reception content showing that a message is received on the smartphone, the smartwatch 2 starts the application to realize the message reception function in the smartwatch 2, and thereby displays the message reception screen G21 and outputs the reception notification sound. This can let customers have simulated experiences of the behaviors of the smartwatch 2 when a message is received on the smartphone.

Further, when receiving message information from the smartwatch 2 after sending the message reception notification information to the smartwatch 2, the hardware processor 23 reproduces the received message information. This can let customers have simulated experiences on how a reply message to a message received on the smartphone is reproduced on the party's side.

### Simulated Experiences with News Reception Function

FIG. 11 shows flow of a process performed by the digital signage apparatus 1 and the smartwatch 2 when the button B3 of the operation unit 32 is pressed and thereby issues an instruction to start reproducing the content introducing the news reception function. Steps of the process on the digital signage apparatus 1 side shown in FIG. 11 is performed by the hardware processor 23 in cooperation with the program(s) stored in the program memory 251. Steps of the process on the smartwatch 2 side shown in FIG. 11 is performed by the hardware processor 201 in cooperation with the program(s) stored in the memory 202.

In the digital signage apparatus 1, when the button B3 of the operation unit 32 is pressed, the hardware processor 23 starts reproducing the content introducing the news reception function of the smartwatch 2 (Step S41). That is, the hardware processor 23 reads the content information on the content introducing the news reception function from the content information memory 252, and projects/displays, with the projector 24, images of the content based on the image data in the read content information on the image formation unit 27. Further, the hardware processor 23 outputs, with the voice output unit 33, voices of the content based on the voice data in the read content information.

In the content introducing the news reception function, for example, first, a content in which a character explains the news reception function, by saying “On the smartwatch, you can receive news, such as weather forecast, received on a smartphone having been paired with the smartwatch.” or the like is reproduced, and next, a video content in which the character informs that it is time for a weather forecast, by saying “It's seven o′clock and time for the weather forecast.” or the like is reproduced.

Next, the hardware processor 23 reproduces, with the projector 24 and the voice output unit 33, a news reception content C41 showing that news (here, weather forecast) is received on the smartphone (Step S42). FIG. 12 shows an example of the news reception content C41. Time at which this news reception content C41 is reproduced is time at which an event to the smartwatch 2 occurs (i.e. the event occurrence time). Hence, the hardware processor 23 sends application-to-start information and news reception notification information to the smartwatch 2 through the communication unit 26 (Step S43). The application-to-start information is information to identify an application to start to realize the news reception function in the smartwatch 2. The news reception notification information is information to notify the news received on the smartphone.

In the smartwatch 2, when receiving the application-to-start information and the news reception notification information through the communication unit 205, the hardware processor 201 starts the application identified by the application-to-start information, and thereby displays a news reception screen G41 on the display 204 and outputs a reception notification sound with the voice output unit 208 (Step S44). FIG. 13 shows an example of the news reception screen G41. As shown in FIG. 13, on the news reception screen G41, the received news is displayed, for example.

When a predetermined time elapses, the hardware processor 23 of the digital signage apparatus 1 stops reproducing the content introducing the news reception function, and returns to reproduction of the normal content.

Thus, during reproduction of the content introducing the news reception function of the smartwatch 2, the hardware processor 23 of the digital signage apparatus 1 sends data of the information (i.e. start-to-application information) on the application to realize the news reception function in the smartwatch 2 and data of the news reception notification information to notify that news is received on the smartphone to the smartwatch 2 through the communication unit 26 when the image formation unit 27 and the voice output unit 33 reproduce the news reception content showing that news is received on the smartphone. Hence, when the digital signage apparatus 1 reproduces the news reception content showing that news is received on the smartphone, the smartwatch 2 starts the application to realize the news reception function in the smartwatch 2, and thereby displays the news reception screen G41 and outputs the reception notification sound. This can let customers have simulated experiences of the behaviors of the smartwatch 2 when news is received on the smartphone.

As described above, according to the digital signage apparatus 1, the hardware processor 23 sends data that is used in a function of the smartwatch 2 to the smartwatch 2 through the communication unit 26 while reproducing content introducing the function.

This can let customers have simulated experiences with the function of the smartwatch 2, the function being introduced by the digital signage apparatus 1, and accordingly can improve advertising effects.

Further, the hardware processor 23 sends the data that is used in the function being introduced by the content to the smartwatch 2 when a reproducing time of the content reaches a predetermined time. This can realize the function in the smartwatch 2, the function being introduced by the digital signage apparatus 1, when a predetermined content is reproduced.

Further, the hardware processor 23 sends, to the smartwatch 2, the data that is used in, among the multiple functions of the smartwatch 2, the function being introduced by the content being reproduced. This can let customers have simulated experiences with the function being introduced by the content being reproduced.

The descriptions in the above embodiment are some preferred examples of the content reproduction system of the present invention, and hence the present invention is not limited thereto.

For example, in the above embodiment, the digital signage apparatus 1 outputs the message received from the smartwatch 2 in the form of a voice, but may output the message in the form of a text.

Further, in the above embodiment, the present invention is applied to a digital signage apparatus that displays images by projecting the images from its projector onto its screen, but not limited thereto. For example, the present invention is also applicable to a display apparatus provided with a liquid crystal display, a plasma display or the like. In this case too, the present invention can exhibit the same effects as the above.

Besides, detailed configurations and detailed actions of the respective apparatuses or devices of the content reproduction system can also be appropriately modified without departing from the spirit of the present invention.

In the above, one or more embodiments of the present invention are described. However, the scope of the present invention is not limited thereto. The scope of the present invention includes the scope of claims below and the scope of their equivalents.

What is claimed is:

1. A content reproduction apparatus comprising a hardware processor, wherein the hardware processor is configured to:
send data that is used in a function of a first communication device to the first communication device while a reproduction unit reproduces content introducing the function.

2. The content reproduction apparatus according to claim 1, wherein the hardware processor is configured to:
control the reproduction unit to reproduce the content introducing the function of the first communication device; and
send the data that is used in the function to the first communication device while the reproduction unit reproduces the content.

3. The content reproduction apparatus according to claim 1, wherein the hardware processor is configured to send the data that is used in the function to the first communication device when a reproducing time of the content reaches a predetermined time.

4. The content reproduction apparatus according to claim 1, wherein
the first communication device has multiple functions, and
the hardware processor is configured to send, to the first communication device, the data that is used in, among the multiple functions, the function being introduced by the content.

5. The content reproduction apparatus according to claim 1, wherein
the function of the first communication device includes a call reception function of receiving a call received on a second communication device which is different from the first communication device, and
the hardware processor is configured to send, to the first communication device, data of information on an application to realize the call reception function and call reception notification information to notify that a call is received on the second communication device when the reproduction unit reproduces a call reception content showing that the call is received on the second communication device.

6. The content reproduction apparatus according to claim 5, wherein the hardware processor is configured to control the reproduction unit to reproduce a talking content showing that the call is accepted when receiving, from the first communication device, talk notification information to notify that the call is accepted.

7. The content reproduction apparatus according to claim 6, wherein the reproduction unit includes a voice output unit which outputs a voice when, from the first communication device, the voice is received after the talk notification information is received.

8. The content reproduction apparatus according to claim 6, wherein the hardware processor is configured to send, to the first communication device, a voice content which is reproduced by the reproduction unit after the hardware processor receives the talk notification information from the first communication device.

9. The content reproduction apparatus according to claim 6, further comprising a voice input unit with which a voice is input, wherein
the hardware processor is configured to send a voice to the first communication device when the voice is input with the voice input unit after the hardware processor receives the talk notification information from the first communication device.

10. The content reproduction apparatus according to claim 5, wherein the hardware processor is configured to control the reproduction unit to reproduce a disconnection content showing that the call is disconnected when receiving, from the first communication device, disconnection notification information to notify that the call is disconnected.

11. The content reproduction apparatus according to claim 1, wherein
the function of the first communication device includes a message reception function of receiving a message received on a second communication device which is different from the first communication device, and
the hardware processor is configured to send, to the first communication device, data of information on an application to realize the message reception function and message reception notification information to notify the message received on the second communication device when the reproduction unit reproduces a message reception content showing that the message is received on the second communication device.

12. The content reproduction apparatus according to claim 11, wherein the hardware processor is configured to control the reproduction unit to reproduce message information when receiving the message information from the first communication device after sending the message reception notification information to the first communication device.

13. The content reproduction apparatus according to claim 1, wherein
the function of the first communication device includes a news reception function of receiving news received on a second communication device which is different from the first communication device, and
the hardware processor is configured to send, to the first communication device, data of information on an application to realize the news reception function and news reception notification information to notify the news received on the second communication device when the reproduction unit reproduces a news reception content showing that the news is received on the second communication device.

14. The content reproduction apparatus according to claim 2, wherein
the first communication device has multiple functions, and
the hardware processor is configured to send, to the first communication device, the data that is used in, among the multiple functions, the function being introduced by the content.

15. The content reproduction apparatus according to claim 1, wherein the first communication device includes a wearable terminal.

16. The content reproduction apparatus according to claim 1, wherein the reproduction unit includes at least one of a projector and a display.

17. A content reproduction method comprising:
reproducing content introducing a function of a communication device; and
sending data that is used in the function of the communication device to the communication device while reproducing the content introducing the function.

18. A non-transitory storage medium storing a computer readable program to cause a computer to function as:
a hardware processor which sends data that is used in a function of a communication device to the communication device while a reproduction unit reproduces content introducing the function.
